(19) United States
(12) Patent Application Publication
(10) Pub. No.: US 2017/0147283 A1
(43) Pub. Date: May 25, 2017

(54) Computer-implemented Method for Controlling the Program Flow of a Training Program

(71) Applicant: Christian WALTER, Vienna (AT)

(72) Inventor: Christian WALTER, Vienna (AT)

(21) Appl. No.: 15/360,480

(22) Filed: Nov. 23, 2016

(30) Foreign Application Priority Data
Nov. 24, 2015 (EP) 15 450 041.7

(51) Int. Cl. G06F 3/16; G09B 19/00; G11B 27/11; G09B 5/06; G06F 3/0488; G06F 3/041

(52) U.S. Cl. CPC G06F 3/165; G06F 3/04883; G06F 3/0416; G11B 27/11; G09B 5/065; G09B 19/00

(57) ABSTRACT

In a computer-implemented method for controlling the program flow of a training program, in particular for mental training, in which the program flow determines the time and order of the playing of electronically stored speech announcements, periodic movements of the user are detected on a touch-sensitive surface and evaluated, and the program flow is controlled as a function of the result of the evaluation.

### RELATED APPLICATION

This application claims the foreign priority benefit of EP Application 15 450 041.7 filed Nov. 24, 2015, the complete disclosure of which is incorporated herein by reference.

### FIELD

The invention relates to a computer-implemented method for controlling the program flow of a training program, in particular for mental training, in which the program flow determines the time and order of the playing of electronically stored speech announcements and sound sequences.

The invention further relates to a computer program product comprising program code means suitable for carrying out the steps of the method according to the invention when the computer program product is implemented on a computing device, and a computing device, in particular smartphone or tablet computer, for carrying out the method according to the invention.

### BACKGROUND

For learning and training various skills, training programs are used, which lead the user through training contents, usually in steps. In the past, learning or training contents have primarily been conveyed by the aid of teaching books and/or by the personal lecture of a tutor or teacher in teaching or training units. Besides, so-called e-learning courses are presently offered, in which teaching or training units recorded in audio and/or video formats are available on sound or video carriers, or for downloading on data processing devices.

Training programs available in audio formats can be used for conveying all kinds of training contents such as speech training, body workout or mental training. As opposed to multimedia training units, the replay of which can be controlled via the graphical user surface of a personal computer and which are, therefore, frequently interactively designed, training programs merely provided in audio format do not require graphical user surfaces and, therefore, offer only limited options for interactive functions. Consequently, training programs provided for audio replay, as a rule, comprise speech announcements that are played in a predetermined temporal order. A variable program flow, during which electronically stored speech announcements or audio signals are played at variable times and in variable order and in which the time and order of playing is automatically optimized as a function of the behavior of the user, is usually not provided. Where the option of influencing the training program is provided, this is mostly based on external sensors provided for defined body functions such as the heart beat or the respiratory rate. In those cases, the playing device for playing electronically stored speech announcements, therefore, has to be elaborately equipped with external sensors.

Training programs with recorded exercises are frequently applied for mental training purposes. Mental training comprises the performance of systematically instructed exercises according to a known mental training technique for the purposeful change of cognitive processes, cognitive patterns or perceptions. Depending on the respective requirements, this will, for instance, allow for a reduction of stress or anxiety states, an increase of the physical or mental efficiency in especially desired fields, or an improvement of the general well-being. In the western industrial countries, in particular, there has been an increasing interest in, and need of, the application of mental training techniques. As with other skills, the acquisition of such techniques, however, requires methodical knowledge and its systematic application as well as motivation and endurance. Not only autodidact trainees, but any participants in respective mental training courses have to be able to do their regular, usually daily, individual stints in a continuous, targeted and completely independent manner at the usual intervals of one week between coach-supported training units. Hence, there is a large commercial application potential worldwide for appropriate supporting methods that are adaptable to individual needs.

When playing speech announcements or recorded exercises, the trainee, by the aid of the instructed assistance, will usually be able to more easily achieve, and more simply preserve, the relaxed state ideal for mental training and ready for association, which on a neuronal level is based on the activation of the parasympathicus and the attenuation of the sympathicus. But they cannot influence the rigidly predetermined training regime other than by stopping or newly positioning the playing process. Such measures would, however, interrupt and disturb the relaxed training state. It is true that the boredom otherwise inevitably increasing due to customization and also inhibiting motivation is partially reduced by the alternating use of several slightly different audio recordings. Yet, it remains in any event disadvantageous that the interaction between active feedback and unconscious body reactions of the trainee and further training instructions precisely tuned thereto, which is important for mental training and will additionally enhance the training intensity, cannot even get started.

Audio-based training programs thus involve the drawback that there is no way of influencing the playing process without having to interrupt, or affecting, the training. As a result, the trainee will normally not, or not for a sufficiently long time, be able to have the necessary concentration on the training contents.

It is, therefore, desirable to be able to influence the program flow in such a manner that the training does not have to be interrupted or will not be affected. The present invention, therefore, aims to specify a technological solution that allows for the influencing of the program flow without the player requiring external sensors for physiological measurements.

### DRAWINGS

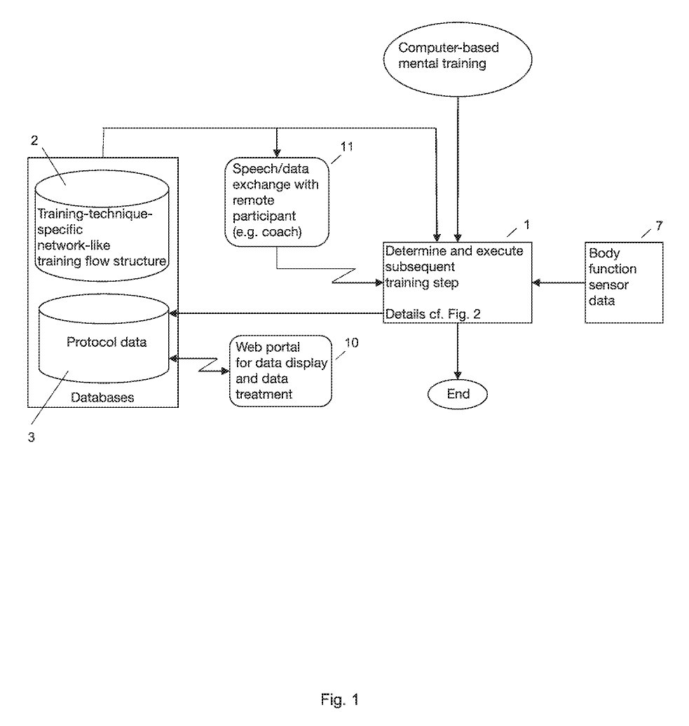

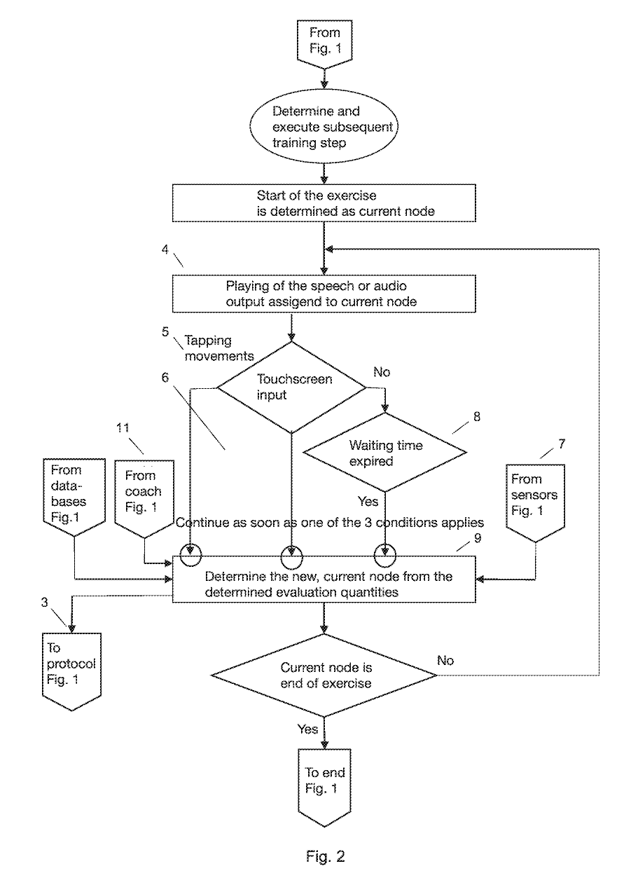

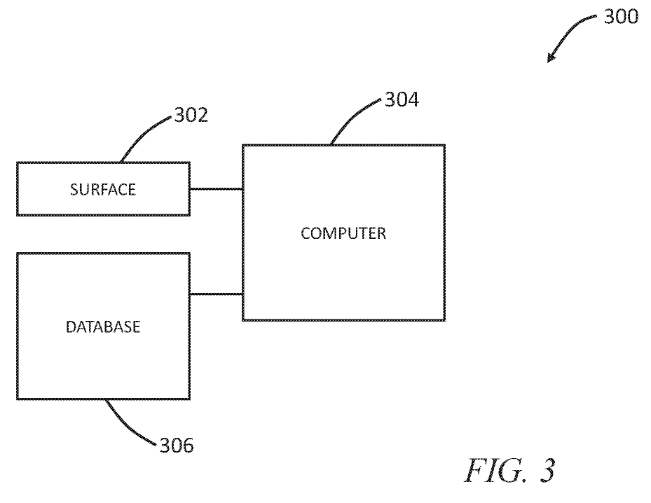

In the following, the invention will be explained in more detail by way of an example schematically illustrated in the drawing. Therein, FIG. 1 illustrates the main process flow of the method according to the invention; and FIG. 2 depicts the process step of determining the subsequent program step in the program flow; and FIG. 3 comprises a block diagram of a system that is configured to control program flow of a training program.

### DESCRIPTION

To solve this object, the invention in a method of the initially defined kind essentially provides that periodic movements of the user are detected on a touch-sensitive surface and evaluated, and the program flow is controlled as a function of the result of the evaluation. In that the control of the program flow is performed by detecting a periodic movement of the user on a touch-sensitive surface rather than by punctual user inputs, a uniform and recurring flow of movements can, for instance, be recognized, which hardly affects the training process and requires a minimum of attention leading away from the training content. Due to its repetitive character, the periodic movement will, furthermore, increase the reliability of the recognition thereof on the touch-sensitive input surface. By periodic movement, a repeating movement or a repeating pattern of movement is, in particular, understood here.

The periodic movements may, for instance, comprise tapping, swiping or dragging movements of the user on the touch-sensitive surface. The periodic movements are preferably performed by the user's finger. A preferred procedure in this context provides that the periodic movement is a reciprocating swiping or dragging movement. The reciprocating movement, in particular during dragging, offers the advantage of requiring no lifting of the finger.

According to a particularly preferred configuration, the periodic movement occurs synchronously with the user's heart beat or respiratory rate. The user thus has to concentrate on their heart beat and/or respiratory rate and perform on the touch-sensitive surface a movement that is synchronous with the heart beat or respiratory rate. This will enhance the user's concentration on their body functions, which is to be aspired particularly in mental training, while, at the same time, allowing a control of the program flow dependently of the respective body function without requiring external sensors therefor.

The invention can be implemented by using appropriately equipped data processing means comprising a memory for the electronically stored speech announcements and audio signals, a playing module for playing said audio signals via an integrated or externally connectable loudspeaker, and a touch-sensitive input surface. The touch-sensitive input surface can, for instance, be designed as a touch pad. A preferred configuration provides that the periodic movements are detected by a touch-sensitive electronic display device, in particular a touch display of a computer such as a smartphone, tablet or personal digital assistant (PDA). A smartphone or a tablet is particularly suitable for realizing the invention, because all necessary hardware components are provided in an integrated manner. The detection and evaluation of the periodic movements of the user and the control of the program flow can be implemented in a program application to be executed on the smartphone or the tablet.

In order to derive from the user's periodic movement a control command for changing the program flow, a preferred procedure provides that the evaluation of the periodic movements comprises the determination of an evaluation quantity, wherein the control of the program flow is performed as a function of said evaluation quantity.

Advantageous, the incidence of the movements, the number of movements, the speed of the movements, the frequency of the periodic movement, in particular the reciprocation, the regularity of the movements, and/or the time interval between two consecutive movements, and/or the pressure level, are determined as said evaluation quantity. If the periodic movement occurs synchronously with the user's heart beat or respiratory rate, the frequency or the regularity of the heart beat or respiration is taken as said evaluation quantity.

The influencing of the program flow as a function of the evaluation of the periodic movements can be effected in various ways. According to a preferred configuration, it is provided that the evaluation quantity is determined continuously or at regular intervals and compared with at least one default limit value, wherein a stored speech announcement and/or respective sound signal assigned to the at least one default limit value is played when said limit value is fallen short of or exceeded. This enables the program flow to react, for instance, to a specific change of the periodic movements by playing a correspondingly adjusted speech announcement. If, for instance, the movements decelerate significantly, or stop altogether, this can be interpreted as an evidence for a lapse of concentration or falling asleep of the user, whereupon a suitable speech announcement will be directed to bringing back or awakening the user.

In an analogous manner, the reaching of a relaxed state by the user will be recognized if the frequency of the respiration is especially regular, or certain time intervals pass between inspirations and expirations.

In a particularly preferred manner, the playing speed of the speech announcement can be varied as a function of the determined evaluation quantity with the pitch remaining constant. Even in this case, it is possible to respond to the user's mental or physical state in connection with the respiration frequency detected via the movements, and reduce the playing speed when a relaxed state of the user has been recognized.

Alternatively or additionally, it can preferably be proceeded in a manner that the pause length between the playing of two consecutive speech announcements is chosen as a function of the determined evaluation quantity.

A further conceivable way of influencing the program flow as a function of the detected movements is preferably feasible in that the playing of a speech announcement is started substantially simultaneously with the beginning of the detected movement, i.e., for instance at the beginning of inspiration or at the beginning of expiration.

In respect to the use of the method according to the invention for mental training, the invention, in short, has the following advantageous features and effects.

On the one hand, finger-tap gestures of the user can be used on the touch-sensitive input surface for the selective control of the training process and for confirming or checking the complete personal willingness to execute the next training step. At predetermined points of the program flow, questions can, moreover, be announced, which can be answered by repeated tapping at a defined number of tapping movements. Furthermore, branching of the training flow according to spontaneous personal requirements has thus become possible. At other, likewise predetermined points, branching options can be announced: e.g. tapping once causes branching back to the start of the program, tapping twice causes branching to the end of the program, etc.

On the other hand, the execution of movement patterns following one's own respiration observation by a finger swiping or dragging movement may lead to an increase in the power of concentration by apperceiving one's own breaths over extended periods of time. The overlay of two modalities (dragging movements by finger and observation of respiration) has a similarly intensifying effect as handwriting, thus increasing one's memory retention.

The executed finger dragging movements can be recorded to establish a movement profile. The evaluation as to the uniformity and straightforwardness of the movement, blackouts, tempo, length, pressure level, the lapsed time between the inversion points, allows for conclusions to be drawn about the respective relaxation level of the trainee.

Furthermore, a real-time calculation of the instantaneous breathing rhythm is possible so as to enable a selective start of the speech output at the time of inspiration or expiration according to training-technique requirements (if, for instance, the trainee is to “absorb” a statement with specific information, the statement will specifically occur at the beginning of inspiration; if the intended content of the statement is, for instance, “calm yourself down”, the statement will specifically occur at the beginning of expiration).

The recognition of a leveling-off of the concentration or an unwanted falling asleep is possible due to the interruption of the dragging movement. An adequate control of the program flow might comprise the playing of the speech announcement and/or a wakeup call with increasing loudness at the end of a predefined time interval without dragging movements (application of the principle of the dead man's button for train drivers in a totally other context).

An otherwise necessary external sensor (e.g. a chest strap for measuring the breathing rhythm) can be obviated. This will save not only the purchase of a sensor but also the efforts involved in mounting the latter and avoiding possible errors due to incorrect mounting as well as any unpleasant and restrictive feelings aroused in the trainee by such a sensor mounted for measurement.

In FIG. 1, the method according to the invention is explained by an example for computer-based mental training. The computer-implemented method accesses the database 2, in which a training-technique-specific, network-like training flow structure is stored. The training flow structure contains all possible training steps of the training program, wherein an electronically stored speech announcement or sound sequence is assigned to at least some of the training steps, or all of the training steps. In the training flow structure, the individual training steps can be represented in a hierarchic structure such as a tree structure. Thus, a specific training step order has to be followed, since the execution of a training step subordinate in the hierarchy presupposes the previous execution of a training step superior in the hierarchy. The training flow structure in this case is configured such that options as to the training step to be executed subsequently are provided at a number of structure nodes.

The aim of the method according to the invention is to determine a program flow, i.e. the time and the order of the execution of the training steps provided in the training flow structure. To this end, the training flow structure stored in the database 2 is used in a method step schematically denoted by 1 in order to determine and execute the subsequent training step. The execution of the subsequent training step in the case of a training step comprising the playing of a speech announcement or sound sequence means that said speech announcement or sound sequence is played by a suitable hardware component of the electronic device on which the method is implemented. When determining the subsequent training step, a speech or data exchange with a remote trainer (e.g. coach) can be additionally performed according to step 11, said trainer being able to intervene in the program flow. In the determination of the subsequent training step, it is, moreover, possible to take into account body function data 8 recorded by suitable sensors.

The program flow is stored in a databank in the form of protocol data 3, which allows the analysis and evaluation of the training program at a later time so as to enable the assessment of, for instance, the training progress. Access to the protocol data is enabled via a web portal 10 for the display of data, and optionally, the treatment of data.

FIG. 2 depicts the detailed processes in the determination of the subsequent training step. Starting point is the current node of the general training flow structure 2, on which the program flow is running. On the current node, the speech announcement or sound sequence assigned to this node is output (step 4). In order to determine the subsequent training step, user input data including periodic movements are detected on a touch-sensitive input surface and evaluated. The user input can be a, preferably periodic, tapping movement 5 or a finger swiping or dragging movement 6. In step 9, the dependence on the detected user input and its evaluation, or upon expiration of a default waiting time 8 without user input the subsequent training step, is determined to control the program flow. The determination of the subsequent training step comprises the determination of a new node from the general training flow structure 2. If the new node is the final node in the training flow structure 2, the training program will be terminated. Otherwise, the process described in FIG. 2 will be repeated.

A major strength of the computer-based mental training method is the interaction between the training instructions determined by the method in compliance with both the respective training targets and the instantaneous training situation from recent and historical data 2, 3 (step 1) and output under the best possible consideration of the current mental state of the trainee (step 4), and the conscious reactions demonstrated by the trainee by tapping movements 5 as a direct consequence thereof as well as the reactions based on self-observation and recorded by dragging movements 6 or by measurements of different known body function sensors 7, whereupon all of the data gathered in this manner are incorporated in the determination of the subsequent training step 9 and optionally also additionally retransmitted directly to the trainee (step 4).

An advantageous configuration offers the opportunity to perform the measurement of the self-observation of a body function by dragging movements 6, which can be done during each of the already running exercises by simple handling without requiring any accessory equipment and without needing additional training time. In a preferred manner, the object of self-observation is one's own breathing behavior. Breathing is the only body function that operates exactly on the threshold between the cognitive and the vegetative nervous systems. Breathing can, therefore, be fully consciously perceived and influenced by us, yet most of the time it is entirely controlled exclusively by the vegetative system without our conscious perception. Hence, the training of an intensified consciousness for one's own perception of breathing is an approach adopted by all recognized mental training techniques in order to achieve a state best suited for mental training, relaxed and ready for association.

The method encourages and controls conscious breathing by instructing the trainee to perform synchronous input movements 6 simultaneously with their own breathing processes, preferably by dragging the finger towards the trainee during inspiration and dragging it away from the trainee during expiration, each time using the same finger on the touch screen of a smartphone or a tablet, or on a touch pad, or by the mouse of a computer.

The method takes advantage of the known motoric learning model. As with handwriting, which, by the hand movements to be performed in a motorically coordinated manner, promotes the attention, and hence the memory retention, of the written contents more strongly than would be the case by the mere recitation, or notional realization, of the same contents at the same time, continuous swiping movements will also result in a deepened and more conscious perception of breathing.

Once started, the execution of breath-accompanying movements by the trainee will be consistently continued while the original exercise is also proceeding. It is only for the execution of the tapping movements 5 possibly required for controlling the flow that the dragging movements are briefly interrupted and immediately resumed thereafter. This enables both the original exercise and the measurement of the self-perception to run simultaneously and independently of each other and be performed by the trainee by the same finger and without requiring eye contact. If expected breath-accompanying dragging movements 6 cannot or no longer be correctly executed for a longer period than a predefined waiting time 8, a reminder instruction will be played as the next output 4, whereby the turning away of one's attention or even undesired falling-asleep during the training will be immediately recognized and hence most effectively prevented.

The extent of uniformity and regularity is determined from the dragging movement data over a previously defined period of time, a high extent being interpreted as deeper relaxation and vice versa. The thus determined and stored 3 values are incorporated in the determination of the subsequent training step 9.

A further advantageous configuration is provided by the option to attach one or several known body function sensor(s) 7 to the trainee for measurement during the ongoing training. The values promptly detected in each case are incorporated in the determination of the subsequent training step 1.

A further advantageous configuration is provided by the option to output during the ongoing exercise and without interruption of the training flow feedback information on the value curve of the currently detected data for self-perception measurement 6, or from measurements of body function sensors 7, by speech announcements and/or sound signals. Such auditory biofeedback enables the trainee to promptly associate and learn which of their behaviors would lead to which mental states so as to more efficiently train a more rapid and reliable evocation and maintenance of a desired state.

A further advantageous configuration is provided by the option to use ways of user feedback other than by tapping movements on the touch screen or mouse click movements. In order to ensure as consistent a user interface as possible, the use of the same selection number is to be provided in all selection options logically belonging together in terms of orientation and purpose. In this context, it is preferred to use selection options with order number two for affirmative feedback or feedback continuing the instantaneous training flow, with order number three for disapproving feedback or feedback interrupting the training flow or requesting additional information of help, with order number four for listing additional selection options, with order number five for returning to either the previously executed action or to the last-performed training step.

A further advantageous configuration is provided by the option, when outputting speech announcements 4, to convey as realistic an impression as possible of the announcing voice in a randomly controlled manner by changes in the speech tempo, breaks or speech-typical concomitant noises like breathing or throat-clearing. This will additionally support the trainee's willingness to get involved in the exercise as unbiased and irritation-free as possible, which is important for the training success.

The aim of as high an acceptance and willingness as possible to use the method will be achieved in that it is, for instance, permanently available as an app on the smartphone and is ready for use for training at any time without comprehensive preparation. A further advantageous configuration is, therefore, provided by the option to install a settable reminder function which, by request, will suggest, either time-controlled or at random times, the respectively best-suited training unit to be executed next, whereupon the latter can also be started immediately by an appropriate input 5, if desired.

A further advantageous configuration is provided by the option to measure how far it is possible to reserve, actually stick to, or even extend, periods of rest and relaxation during one's daily routine. To this end, the trainee defines random time intervals at which an additional recording 3 of all activities is implemented on the used device, preferably a smartphone. To this end, all performed activities such as phone calls, internet accesses or program activations are counted in groups, and their respectively required execution times are summed up in groups. In doing so, the activities are only captured in terms of quantity, and there will be no access to, or even storage of, concrete contents. The trainee will thus obtain an overview of his/her user behavior and be able to provide planned use breaks or define a desired use behavior and trace the pursuit of their goal over any desired periods of time.

For the use of all hitherto-mentioned configurations, no data trunk connection is required for carrying out the method proper. In other words, if only the functionalities described so far are required, a customary smartphone in the so-called offline mode will do for its application. Advantageously, no running costs will be incurred, all training data will be safe from undesired or unintentional electronic circulation, and no mobile phone radiation will occur.

The following advantageous configurations additionally use the options available on smartphones or computers for setting up speech or data trunk connections.

One of these advantageous configurations provides the option to upload on the internet 10 special training protocol information and associated comments in a web portal provided therefor. This option for exchange will allow for an increase in the knowledge, motivation and willingness for training within a group of persons training or exercising individually.

Another advantageous configuration provides the option to establish a contact with one or several remote participants, typically a coach or mental trainer 11, before or during an exercise, which will enable to not only observe or check data and audio signals 2, 3, 4 currently available from the trainee but, if required, also control and intervene in the ongoing training step determination 9, or connect with the trainee in a direct speech or chat connection 11.

Referring now to FIG. 3, a system 300 that is configured to control the program flow of a training program is described. Program flow of the training program determines the time and order of the playing of electronically stored speech announcements and sound sequences. The system 300 includes a touch-sensitive surface 302, a computer 304, and databases 306.

The databases 306 store a training-technique-specific, network-like training flow structure. The touch-sensitive surface 302 is configured to detect periodic movements of the user. The computer 304 is coupled to the touch-sensitive surface 302 and the databases 306. The computer 304 is configured to perform an evaluation of the periodic movements, and to control the program flow based upon the result of the evaluation.

In aspects, the periodic movement is a reciprocating, swiping, or dragging movement. In other aspects, the periodic movement occurs synchronously with a heartbeat of the user or a respiratory rate of the user.

In some examples, the periodic movements are detected by a touch-sensitive electronic display device. The touch-sensitive electronic display device may be a touch display of a smartphone, a touch display of a tablet, or a touch display of a personal digital assistant (PDA). Other examples are possible.

In yet other aspects, the evaluation of the periodic movements by the computer 304 comprises a determination of an evaluation quantity. The control of the program flow is performed as a function of the evaluation quantity. In some examples, the evaluation quantity determines an incidence of the movements, a number of movements, a pressure level, a speed of the movements, a frequency of the periodic movement including a reciprocation, a regularity of the movements, or a time interval between two consecutive movements. In other examples, the evaluation quantity is determined continuously or at regular intervals, and is compared with at least one default limit value. A stored speech announcement assigned to the at least one default limit value (or a sound signal), is played when the limit value is not reached or is exceeded.

In some examples, the playing speed of the speech announcement is varied as a function of the determined evaluation quantity.

In other examples, the pause length between the playing of two consecutive speech announcements is chosen as a function of the determined evaluation quantity. In yet other examples, playing of a speech announcement is started substantially simultaneously with the beginning of the detected movement.

1. A computer-implemented method for controlling the program flow of a training program, in particular for mental training, in which the program flow determines the time and order of the playing of electronically stored speech announcements and sound sequences, characterized in that periodic movements of the user are detected on a touch-sensitive surface and evaluated, and the program flow is controlled as a function of the result of the evaluation.

2. A method according to claim 1, characterized in that the periodic movement is a reciprocating swiping or dragging movement.

3. A method according to claim 1, characterized in that the periodic movement occurs synchronously with the user's heart beat or respiratory rate.

4. A method according to claim 1, characterized in that the periodic movements are detected by a touch-sensitive electronic display device, in particular a touch display of a computer such as a smartphone, tablet or personal digital assistant (PDA).

5. A method according to claim 1, characterized in that the evaluation of the periodic movements comprises the determination of an evaluation quantity, wherein the control of the program flow is performed as a function of said evaluation quantity.

6. A method according to claim 5, characterized in that the incidence of the movements, the number of movements, the pressure level, the speed of the movements, the frequency of the periodic movement, in particular the reciprocation, the regularity of the movements, and/or the time interval between two consecutive movements, are determined as said evaluation quantity.

7. A method according to claim 5, characterized in that the evaluation quantity is determined continuously or at regular intervals and compared with at least one default limit value, wherein a stored speech announcement assigned to the at least one default limit value, or a sound signal, is played when said limit value is fallen short of or exceeded.

8. A method according to claim 5, characterized in that the playing speed of the speech announcement is varied as a function of the determined evaluation quantity.

9. A method according to claim 5, characterized in that the pause length between the playing of two consecutive speech announcements is chosen as a function of the determined evaluation quantity.

10. A method according to claim 5, characterized in that the playing of a speech announcement is started substantially simultaneously with the beginning of the detected movement.

11. A computer program product comprising program code means suitable for carrying out the steps of a method according to claim 1, when the computer program product is implemented on a computing device.

12. A computing device, in particular smartphone or tablet, for carrying out the computer-implemented method for controlling the program flow of a training program according to claim 1, wherein the computing device comprises a touch-sensitive surface, characterized in that the computing device is programmed with a computer program product for carrying out said computer-implemented method for controlling the program flow of said training program.

13. A system for controlling the program flow of a training program in which a program flow determines the time and order of the playing of electronically stored speech announcements and sound sequences, the system comprising:
a database storing a program flow;
a touch-sensitive surface that is configured to detect periodic movements of the user; and
a computer that is coupled to the touch-sensitive surface and the database, the computer configured to perform an evaluation of the periodic movements, and to control the program flow based upon the result of the evaluation.

14. A system of claim 13, wherein the periodic movement is a reciprocating, swiping, or dragging movement.

15. A system of claim 13, wherein the periodic movement occurs synchronously with a heartbeat of the user or a respiratory rate of the user.

16. A system of claim 13, wherein the periodic movements are detected by a touch-sensitive electronic display device.

17. The system of claim 16, wherein the touch-sensitive electronic display device is a touch display of a smartphone, a touch display of a tablet, or a touch display of a personal digital assistant (PDA).

18. A system of claim 13, wherein the evaluation of the periodic movements by the computer comprises a determination of an evaluation quantity, and wherein the control of the program flow is performed as a function of the evaluation quantity.

19. A system of claim 18, wherein the evaluation quantity determines: an incidence of the movements, a number of movements, a pressure level, a speed of the movements, a frequency of the periodic movement including a reciprocation, a regularity of the movements, or a time interval between two consecutive movements.

20. The system of claim 18, wherein the evaluation quantity is determined continuously or at regular intervals and compared with at least one default limit value, wherein a stored speech announcement assigned to the at least one default limit value is played when the limit value is not reached or is exceeded.

21. A system of claim 18, wherein playing speed of the speech announcement is varied as a function of the determined evaluation quantity.

22. A system of claim 18, wherein a pause length between the playing of two consecutive speech announcements is chosen as a function of the determined evaluation quantity.

23. A system of claim 18, wherein playing of a speech announcement is started substantially simultaneously with the beginning of the detected movement.
